(19) United States
(12) Patent Application Publication
(10) Pub. No.: US 2013/0221142 A1
(43) Pub. Date: Aug. 29, 2013

(54) Trailer for Shredding and/or Mixing

(71) Applicant: Carlo SCIRPO, Conselve (IT)

(72) Inventor: Carlo SCIRPO, Conselve (IT)

(21) Appl. No.: 13/544,459

(22) Filed: Jul. 9, 2012

(30) Foreign Application Priority Data
Feb. 29, 2012 (IT) VR2012U000008

(51) Int. Cl. B02C 21/02

(52) U.S. Cl. 241/98

(57) ABSTRACT

A shredding and/or mixing trailer has a frame on which a body is mounted, shredding and/or mixing mechanisms being inside the body.

### SPECIFICATION

The present invention refers, in general, to a shredding and/or mixing trailer. More particularly, the invention refers to a shredding and/or mixing trailer which is hauled by an industrial tractor.

In the zootechny, an improvement in the cattle-breeding, sheep-breeding or goat-breeding is reached by utilizing the so-called “one dish” or “unifeed” technique according to which the animals in question are fed only with one mixture which is obtained by mixing several different products. In this way, there is no risk that the animal eats only its preferred food.

The mixture in question is prepared in the inside of an adequate shredding and/or mixing trailer in which all the components of a wished recipe are poured.

The known trailers are equipped with devices which shred said components, poured in their bodies, and mix these components to obtain an only well-mixed product.

In fact, one or more augers are disposed in the inside of the body so as to shred and mix the components since said augers rotate about their horizontal or vertical axes. In the vertical augers, the mixing is more efficient for the effect of an elevation and fall of the components in the inside of the body, which allows to obtain a softer mixture.

The trailers for the preparation of the shredded and mixed product, the so-called “unidish”, are in general trailers or self-propelled trailers.

In case of trailers, the trailers are moved by the power take off of a farm tractor which allows the working of the operative elements in the inside of the trailer through a cardan shaft and a kinematic transmission system, usually an epyciclic reduction gear.

In case of the self-propelled trailers, the trailers move without being hauled by a farm tractor since this typology of trailers is equipped with a motor allowing their movement and working.

Hence, the trailers are not apt to produce the shredded and mixed product unless these trailers are connected to an outer motor and always require to be connected to a farm tractor.

Besides, the power of the farm tractor allowing their movements and operations must be sufficiently high to shred and mix the components in the trailer body. To this end, a much higher power is required than the power required only to haul the trailer.

Concerning the self-propelled vehicles, these vehicles must have at least a power equal to that of the above mentioned farm tractor for the hauling of trailers.

Both in case of trailers and in case of self-propelled vehicles, the speed reached in the displacements on the road is limited since both the typologies of vehicles are subjected to the maximal speed restrictions imposed to the farm vehicles, which involves an unwished time cost in case the vehicle must be moved to distant places.

An aim of the invention is to overcome the above mentioned drawbacks and other ones by carrying out a shredding and mixing trailer which is versatile and flexible regardless of the vehicle used to haul the trailer.

A further aim of the invention is to carry out a shredding and mixing trailer which allows to prepare a mixture and to transport the same to other places.

Another aim of the invention is to offer a shredding and mixing trailer in which a lower external power is required to obtain the wished product.

All said aims and advantages are reached according to the invention through a shredding and/or mixing trailer comprising a frame on which a body is mounted, shredding and/or mixing means being comprised in the inside of the body, and apt to be hauled.

The trailer is characterized by the fact of comprising one or more motors to move said shredding and/or mixing means.

The presence of one or more motors allows the trailer to be utilized for the shredding and/or mixing in an independent way, without being connected to external motors and/or external tractors. The trailer according to the invention has one or more motors on board and can be hauled by an industrial tractor or a road tractor having a lower power than the power required for a farm tractor apt to move the components of an equivalent trailer as carried out according to the known art.

The trailer can be maintained stationery to produce the mixture to be distributed for instance with other movable means having smaller capacity and size and consequently a better ease of movements.

Advantageously, the frame can comprise a first part and a second part which are separable from each other. The first part supports the motor and the second part supports the body. The first part and the second part can be coupled through coupling means.

In this way, the frame can be subdivided and consequently, the trailer can be separated into two parts, which facilitates operations such as the transport of the single parts having lower dimensions than the trailer.

In addition, the shredding and/or mixing means can be connected to the motor through means of transmission and one or more reduction gears. The one or more reduction gears are placed at a height from the ground which is lower than height of the motor. Thus, it is possible for the motor to be placed on the first part of the frame, at an upper height than the bottom of the body, under which the one or more reduction gears are placed. This height difference is overcome through the means of transmission.

Advantageously, the means of transmission can comprise a clutch, a first transmission and one or more cardan joints, arranged in cascade to the motor. The one or more cardan joints can comprise a first cardan joint, a first change gear, a second cardan joint, a second change gear and a third cardan joint, each of them being connected to the next one. In addition, each of them has a first end at which it receives the motion from the previous element as well as a second end from which it transmits the motion to the next one; each of said first ends is disposed at a height from the ground which is upper than the height of the respective second end.

The particular arrangement of the first change gear and second change gear and their particular cascade arrangement makes it possible to overcome the above mentioned height difference. Besides, it is possible to maintain an inclination of the cardan joints which is lower than the limit inclination in order to obtain an optimum running.

Advantageously, the means of transmission comprises mechanical transmission element. In this way, the transmission of the motion from the motor to the shredding and/or mixing means takes place with a transmission efficiency which is guaranteed by a mechanical transmission and which is much higher than the hydraulic transmissions which are commonly utilized in the known shredding and/or mixing means.

Advantageously, the body can be provided with one or more front discharge doors near a first end of the body and/or one or more rear discharge doors near a second end of the body so that the contents in the body can be evacuated to the outside.

In addition, one or more guillotine doors can be connected near one or more discharge doors in the body so as to slide and are fixed to a first end of one or more actuators. A second end of the one or more actuators is fixed to the body so that the one or more actuators move the one or more guillotine doors from a first position in which the one or more guillotine doors cover the one or more discharge doors to a second position in which the one or more guillotine doors free the one or more discharge doors, and vice versa. In this way, each discharge door can be opened or closed partially or completely according to the operator and according to the wished discharge speed.

Advantageously, one or more augers can be comprised in the inside of the body to shred and/or mix the material contained in the body, the one or more augers being operated by the motor through means of transmission. Besides, the one or more augers can have a vertical axis of rotation. In fact, the vertical augers allow to perfectly mix the components and, in combination with the above mentioned discharge doors, allow also to easily evacuate the body contents.

In addition, a trailer according to the invention can comprise a first self-steering axle, a second filed axle and a third self-steering axle. In this way, the presence of self-steering axles allows to reduce the consumption for the towing of the trailer and to reduce the tire wear.

Besides, a system of realignment can be comprised to facilitate the reverse motion of the trailer according to the invention.

Advantageously, the body can be connected to the frame through one or more charge cells so that it is possible to measure the weight of the body contents.

Advantageously, the means of transmission can comprise a clutch dedicated to each single gear; each clutch is controlled and managed electronically so that it is possible to disconnect a gear and at the same time, it is possible to connect a different gear. In this way, it is possible to change gear during the operation of the shredding and/or mixing means under load.

Advantageously, a trailer according to the invention can comprise a coupling device so as to be coupled with a road tractor. In this way, for the towing of this trailer it is possible to utilize a generic road tractor having a sufficient power to haul the trailer in question. However, this power is lower than the power required to actuate the shredding and/or mixing means.

Further features and details of the invention will be better understood from the following specification, which is supplied as a non-limiting example, as well as from the accompanying drawings wherein:

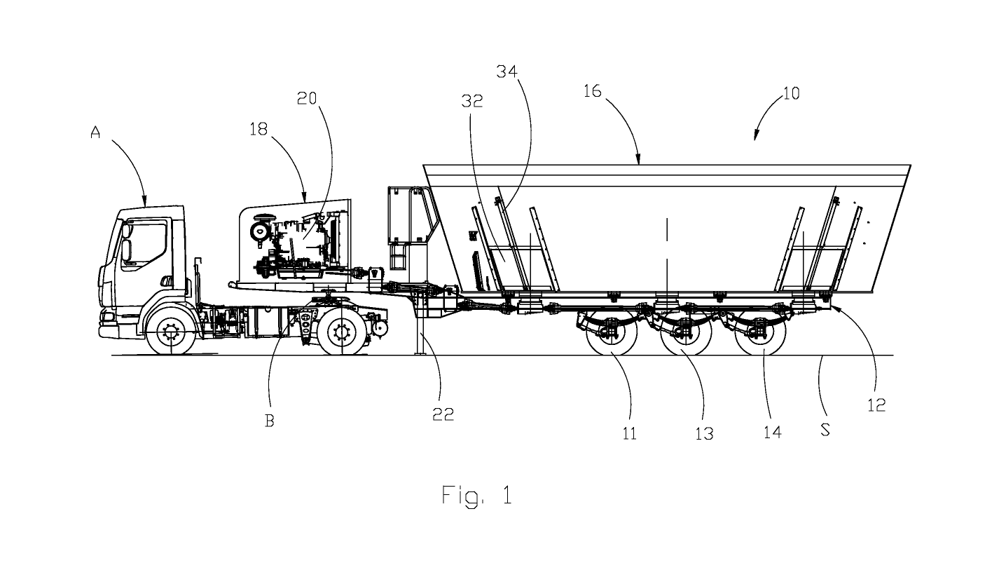

FIG. 1 is a schematic side view of a shredding and/or mixing trailer according to the invention, this trailer being coupled with a road tractor;

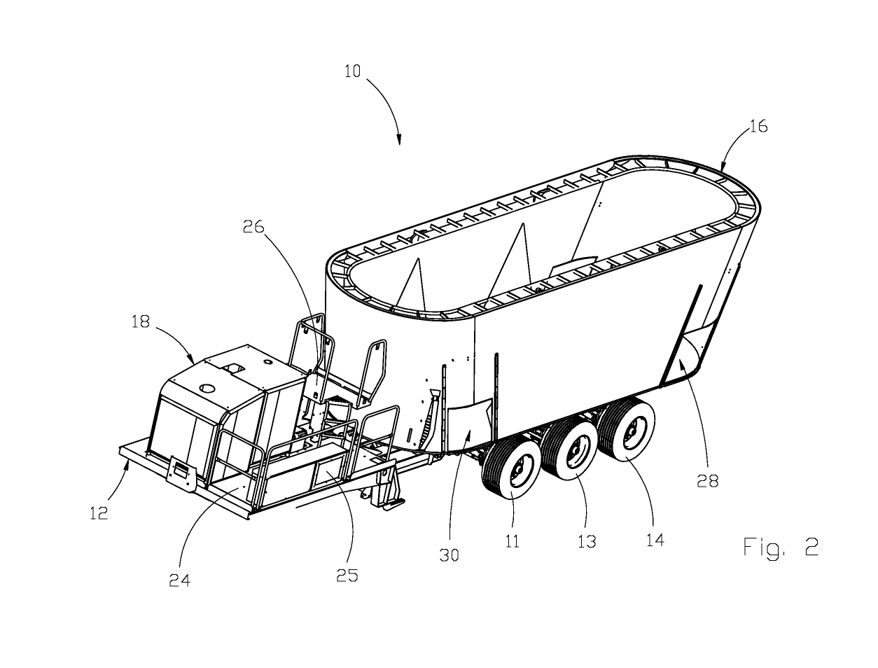

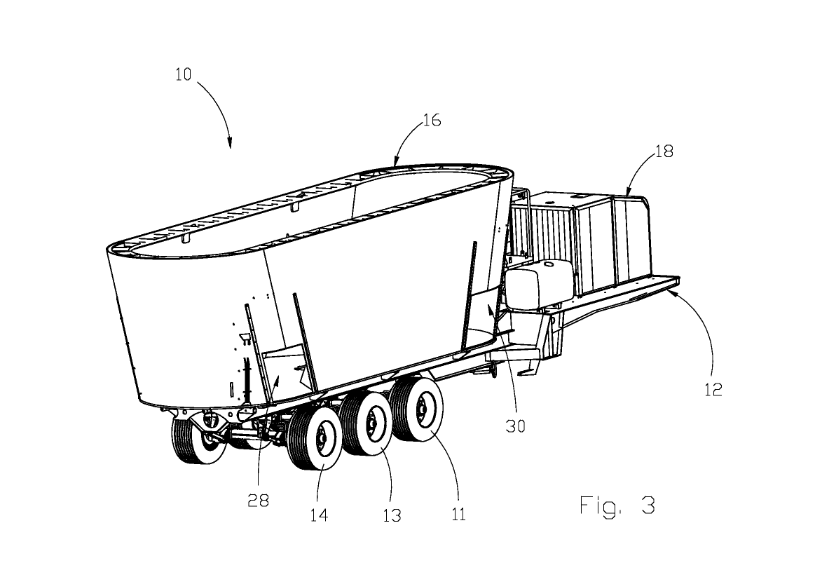

FIGS. 2, 3 are axonometric views of the two sides of a shredding and/or mixing trailer according to the invention;

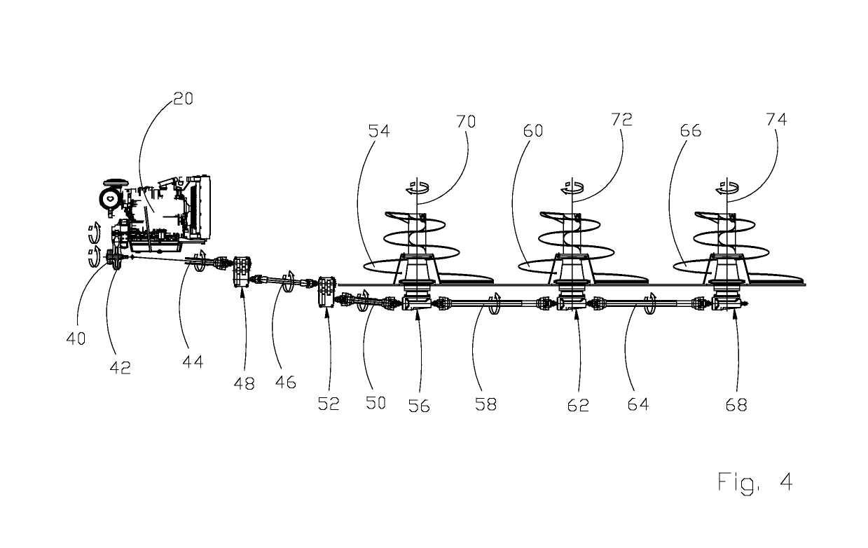

FIG. 4 is a schematic view of a system of transmission of the shredding and/or mixing trailer according to the invention; and

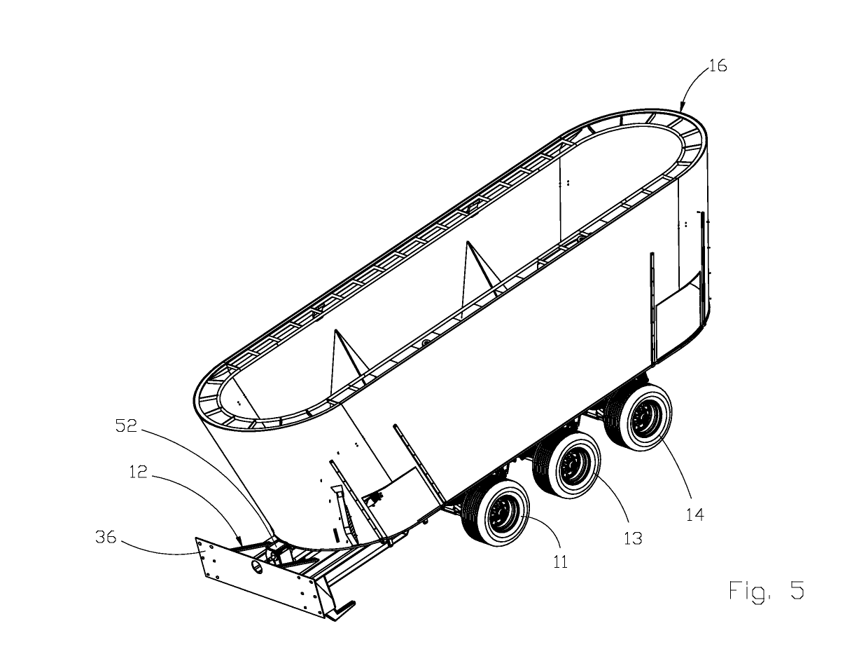

FIG. 5 is an axonometric view of a component of the shredding and/or mixing trailer according to the invention.

With reference to the accompanying figures, and in particular to FIG. 1, number 10 denotes a shredding and mixing trailer, called trailer below, coupled with a road tractor A by means of its trailing hook B.

The trailer 10 comprises a frame 12 which is supported over the ground S by an axle 11, a second axle 13 and a third axle 14 with their respective wheels. The first axle 11 and the third axle 14 are self-steering while the second axle 13 is fixed. A controlled steering system allows to lock and/unlock the steering in reverse. Obviously, all the axles of the trailer 10 can be fixed. Otherwise, whether the axles are self-steering, they can be provided with a steering system which is controlled by the fifth wheel of the road tractor A directly.

A body 16 is coupled with the frame 12 by means of eight load cells which allow an appropriate weighing of the load, which is useful to manage the recipes to be prepared. Besides, a head 18 comprising a motor 20 and other operative means for the trailer 10 is fixed to the frame 12.

The trailer 10 rests on the ground S also by means of two retractable feet 22 of which only one is visible in FIG. 1, which allows the release of the semitrailer from the tractor.

As visible in FIGS. 2 and 3, near the head 18, a platform 24 is put on the frame 12 so that an operator can get on the platform 24 to inspect the components of the head 18, to perform maintenance operations and to perform the necessary supplies. In addition, from the platform 24 the operator can get on a turret 26 which is placed at a higher level than the platform 24. From the turret 26 the operator is able to control the inside of the body 16.

A control panel 25 is put on the platform 24 and is, therefore, accessible for the operator standing on the ground S and it is not necessary for the operator to get on the platform 24.

Two fore discharge doors 30 are obtained in the body 16 near the head 18 and two rear discharge doors 28 are obtained in the opposed end of the body 16.

Once the product has been treated in the inside of the body and a guillotine door 32 (visible in FIG. 1) covering the relevant discharge door, has been lifted, the product can be evacuated from the discharge doors. The lifting of the guillotine door 32 takes place through a hydraulic actuator 34.

As visible in FIG. 4, the motor 20 is connected through an electro-hydraulic clutch 40 and a first transmission 42 to a first cardan joint 44 which transmits the motion to a second cardan joint 46 by means of a first change gear 48. The motion is transmitted through the second cardan joint 46 to a third cardan joint 50 by means of a second change gear 52.

The third cardan joint 50 transmits the motion to a first auger 54 through a first reduction gear 56 which in turn transmits the motion to a fourth cardan joint 58.

Likewise, the fourth cardan joint 58 transmits the motion to a second auger 60 through a second reduction gear 62 which in turn transmits the motion to a fifth cardan joint 64.

The fifth cardan joint 64 transmits the motion to a third auger 66 through a third reduction gear 68. The number of the augers is variable and the augers can be vertical or horizontal.

In the inside of the body 16, not visible in FIG. 4, the first auger 54, the second auger 60 and the third auger 66 rotate around a first axis of rotation 70, a second axis of rotation 72 and a third axis of rotation 74, respectively.

The presence of the first change gear 48 and second gear 52 allows to transmit the motion from the motor 20, housed in the head 18, to the first reduction gear 56 and then to the augers on overcoming the height difference between the first transmission 42 and the first reduction gear 56 and limiting, at the same time, as much as possible the angles of inclination to the ground S of the first cardan joint 44, second cardan joint 46 and third cardan joint 50.

As it appears from FIG. 5, the frame 12 comprises a connecting plate-shaped element 36 which makes possible the separation of the frame itself into two distinct parts of which a first part of the frame 12 supports the body 16 and a second part of the frame 12 supports the head 18. This separation of the frame 12 allows to improve the transportability of the trailer 10, in particular in case of a modular transport such as in the naval transport in which each part of the trailer 10 can be loaded independently. For instance, the first part along with the body 16 supported by the this part can be loaded on a container with a flat stowage, known as “flat rack” while the second part, which supports the head 18, can be loaded comfortably in a container of a known typology.

The first part and the second part are joined together by means of a bolted connection and an interface for the hydraulic and electric connections.

Alternatively, the frame 12 can be carried out in an only piece without being divided into two parts.

From the control panel 25 it is possible to control a series of working parameters of the trailer 10, to control the movements of its components and to perform the shredding and mixing operations as well as the distributing operations.

For instance, it is possible to visualize all the parameters of the motor 20, the weight measured by the load cells, any signalling light of alarms, presence of tension or other.

Besides, it is possible to control and monitor the motor 20 and all the uses such as the engagement and transmission of the augers, the opening and closing of the discharge doors, the gear shift of the first change gear 48 and the second change gear 52 to adjust the speed of rotation of the augers, the locking or unlocking of the steering for the self-steering axles.

In addition, the control panel 25 comprises emergency buttons to stop any operation of the trailer 10 as well as an only starting control.

The trailer 10 according to the invention comprises a remote control unit, not visible in the drawing, which allows to remote control the above mentioned functions in the control panel 25. There is no starting control in the remote control unit to avoid dangerous remote starts.

The distribution operation to distribute the product mixed in the body 16 is performed by controlling the opening of one or more discharge doors through the opening of the guillotine doors 32 or through the guillotine door of the specific discharge door. The movement of the auger near the open discharge door provokes the ejection of the mixed product out of the body 16, for instance by pouring it in the mangers directly. When the distance between a discharge door and the place of destination is considerable, a conveyor belt (not represented in the drawing) is utilized. The conveyor belt is connected near the relative discharge door so as to overcome distances of some meters.

The utilization of a mechanical transmission to directly transmit the motion from the motor 20 to the augers permits to maintain the efficiency of the transmission high while the known art utilizes a hydraulic transmission having a considerably lower efficiency.

Besides, the trailer according to the invention provides that the first reduction gear 56, the second reduction gear 62 and the third reduction gear 68 utilize reducers of adequate dimensions for heavy uses in order to transmit the motion to the respective augers.

The shredding and/or mixing trailer 10 according to the invention can be considered as a road semitrailer, with the consequent advantage of not being limited, in its road moving, to the speed limits imposed to a farm vehicle.

A consequent advantage is the possibility of preparing a mixture of product in a determined place and bring the product to other places where the premixed product can be utilized.

Since the trailer according to the invention has the motor 20 on board, the trailer can be hauled by an industrial or road tractor which has a lower power than the power required for a farm tractor moving the components of an equivalent trailer conceived according to the known art.

In fact, the trailer according to the invention can be hauled by road or industrial tractors with homologated coupling and allows a best interchangeability in comparison with the known trailers.

In addition, the presence of the motor in the trailer according to the invention permits to maintain the trailer stationary and to us the trailer for the production of the mixture to be distributed, for instance, with other movable means having smaller capacity and dimensions and therefore, a consequent greater facility as concerns the movements.

Besides, the advantage of being homologated as semitrailer permits lower costs for the transport from the building place of the trailer to the user since the trailer can be hauled to the client while the self-propelled vehicles and the trailers according to the known art must be loaded on a vehicle.

According to a variant of the invention, a shredding and/or mixing trailer can comprise a system of transmission including a clutch dedicated to each single gear or speed. Each clutch is controlled and managed electronically so as to disengage a gear or speed while at the same time a different gear or speed is engaged. Through said system of transmission, a sudden change is obtained and also the change of the gears under load is possible without stopping the shredding and mixing operations during the change.

It is to be intended that in the scope of protection of the invention, other variants of the trailer according to the invention are included. For instance, the number of the augers in the body 16 can be different from three and the augers can have an axis different from the vertical axis.

1. Shredding and/or mixing trailer (10) comprising a frame (12) on which a body (16) is mounted, shredding and/or mixing means (54, 60, 66) being comprised in the inside of the body (16), and is adapted to be hauled;
characterized by the fact of comprising at least a motor (20) actuating said shredding and/or mixing means (54, 60, 66).

2. Trailer(10) according to claim 1, wherein the frame (12) comprises a first part and a second part which are separable from each other; said first part supports the motor (20) and said second part supports the body (16); said first part and said second part are adapted to be coupled through coupling means.

3. Trailer (10) according to any claim 1, wherein the shredding and/or mixing is means (54, 60, 66) are connected to the motor (20) through transmission means (40, 42, 44, 46, 48, 50, 52, 58, 64) and at least a reduction gear (56, 62, 68); said at least a reduction gear (56, 62, 68) is put at a lower height from the ground (S) than the height of the motor (20).

4. Trailer (10) according to claim 3, wherein said transmission means comprises:
a clutch (40);
a first transmission (42);
at least a cardan joint (44, 46, 50);
all of them being disposed in cascade to the motor (20).

5. Trailer (10) according to claim 4, wherein the at least a cardan joint comprises a first cardan joint (44), a first change gear (48), a second cardan joint (46), a second change gear (52) and a third cardan joint (50); each of said elements is connected to the following one and has a first end which s receives the motion from the preceding element and a second end from which the element in question transmits the motion to the following one; each of said first ends is placed at an upper height from the ground (S) than the respective second end.

6. Trailer (10) according to claim 3, wherein said transmission means comprises elements of mechanical transmission.

7. Trailer (10) according to claim 1, wherein at least a front discharge door (30) is obtained near a first end of the body (16) and/or at least a rear is discharge door (28) is obtained in the second end of the body (16).

8. Trailer (10) according to claim 7, wherein near at least a discharge door (28, 30), at least a guillotine door (32) is connected to the body (16) so as to slide, which at least a guillotine door (32) is fixed to a first end of at least an actuator (34) and a second end of the at least an actuator (34) is fixed to the body (16) so that the at least an actuator (34) moves the at least a guillotine door (32) from a first position in which the at least a guillotine door (32) covers the at least a discharge door (28, 30) to a second position in which the at least a guillotine door (32) frees the at least a discharge door (28, 30) and vice versa.

9. Trailer (10) according to claim 1, wherein at least an auger (54, 60, 66) is comprised in the inside of the body (16) and is adapted to shred and/or mix s any contents in the body (16), said at least an auger (54, 60, 66) being actuated by the motor (20) through transmission means (40, 42, 44, 46, 48, 50, 52, 56, 58, 62, 64, 68).

10. Trailer (10) according to claim 9, wherein the at least an auger has a vertical axis of rotation.

11. Trailer (10) according to claim 1, comprising a first axle which is a self-steering axle (11), a second axle which is a fixed axle (12) and a third axle which is a self-steering axle (13).

12. Trailer (10) according to claim 1, wherein the body (16) is connected through at least a load cell to the frame (12) in order to measure the weight of the contents in the body (16).

13. Trailer (10) according to claim 3, wherein the transmission means comprises a clutch dedicated to each single gear and each clutch is controlled and managed electronically so that a gear is disengaged while, at the same time, a different gear is engaged.

14. Trailer (10) according to claim 1, wherein a coupling device is comprised to be coupled with a road tractor.
